(19) United States
(12) Patent Application Publication
(10) Pub. No.: US 2018/0257006 A1
(43) Pub. Date: Sep. 13, 2018

(54) SUCTION FILTER AND FUEL SUPPLY DEVICE

(71) Applicant: DENSO CORPORATION, Kariya-city, Aichi-pref. (JP)

(72) Inventors: Norihiro HAYASHI, Kariya-city (JP); Shinobu OIKAWA, Kariya-city (JP); Kiyoshi NAGATA, Kariya-city (JP); Tetsuro OKAZONO, Kariya-city (JP)

(21) Appl. No.: 15/542,525

(22) PCT Filed: Jan. 13, 2016
(86) PCT No.: PCT/JP2016/000135

§ 371 Date: Jul. 10, 2017

(30) Foreign Application Priority Data
Jan. 15, 2015 (JP) 2015-6179
Jul. 16, 2015 (JP) 2015-142169
Dec. 9, 2015 (JP) 2015-240567

(51) Int. Cl. B01D 29/11; B01D 35/02; F02M 37/22; B01D 29/00

(52) U.S. Cl. CPC B01D 29/114; B01D 35/02; F02M 37/10; B01D 29/0054; F02M 2037/228; F02M 37/22

(57) ABSTRACT

A suction filter which filters fuel inside a fuel tank of a vehicle to let a fuel pump draw filtered fuel into an inlet port includes a filter element disposed inside the fuel tank and filtering stored fuel stored in the fuel tank by allowing the stored fuel to pass through to an inner space, and a partition wall element disposed in a posture with which to divide the inner space to a first space where filtered fuel filtered at the filter element flows in and a second space where the inlet port into which the filtered fuel is drawn opens, and allowing the filtered fuel in the first space to pass through to the second space. The partition wall element is provided in a form of a partition film dividing the inner space to the first space on an upper side and the second space on a lower side.

### CROSS REFERENCE TO RELATED APPLICATION

This application is based on Japanese Patent Application No. 2015-6179 filed on Jan. 15, 2015, Japanese Patent Application No. 2015-142169 filed on Jul. 16, 2015, and Japanese Patent Application No. 2015-240567 filed on Dec. 9, 2015, the disclosures of which are incorporated herein by reference.

### TECHNICAL FIELD

The present disclosure relates to a suction filter and a fuel supply device provided with a suction filter.

### BACKGROUND ART

A fuel supply device in the related art supplying fuel from inside a fuel tank to outside the fuel tank in a vehicle includes a fuel pump disposed inside the fuel tank. The fuel pump draws fuel into an inlet port and discharges the drawn fuel outside the fuel tank. A device disclosed in Patent Literature 1 as an example of the fuel supply device in the related art is provided with a suction filter for the fuel pump to draw fuel into the inlet port after fuel is filtered inside the fuel tank.

The suction filter disclosed in Patent Literature 1 includes a filter element disposed inside the fuel tank. The filter element filters fuel stored in the fuel tank (hereinafter, referred to as the stored fuel) while forming a liquid film by allowing the stored fuel to pass through to an inner space. The liquid film is maintained while an outer surface of the filter element is in contact with the stored fuel. By taking such a property into consideration, the suction filter disclosed in Patent Literature 1 is configured in such a manner that an outer space of the filter element is partially covered with a storing member inside the fuel tank. Owing to the configuration as above, even when the stored fuel migrates to only one side inside the fuel tank during turning motion or the like of the vehicle and a liquid surface tilts to an extent that the stored fuel loses contact with the filter element, a part of the outer surface of the filter element remains in contact with fuel trapped between the storing member and the filter element. Hence, because the filter element maintains a liquid film formation state, fuel becomes a predominant subject to be drawn into the inner space where the inlet port opens. Consequently, drawing of air into the inlet port can be restricted.

### PRIOR ART LITERATURES

### Patent Literature

Patent Literature 1: JP2012-67736A

### SUMMARY OF INVENTION

The suction filter disclosed in Patent Literature 1, however, has an inflow hole provided to the storing member to let fuel flow into a space between the filter element and the storing member. Hence, fuel in the space between the filter element and the storing member readily leaks out from the inflow hole when the liquid surface tilts during turning motion or the like of the vehicle. Accordingly, an amount of trapped fuel in the space between the filter element and the storing member is reduced and an amount of the trapped fuel becomes insufficient in a short time while fuel is drawn into the inlet port. Hence, air may possibly be drawn into the inlet port. Drawing of air into the inlet port as above is not preferable because discharge performance of the fuel pump fluctuates.

An object of the present disclosure is to provide a suction filter which stabilizes discharge performance of a fuel pump and a fuel supply device provided with such a suction filter.

According to a first aspect of the present disclosure, the suction filter which filters fuel inside a fuel tank of a vehicle to let a fuel pump draw filtered fuel into an inlet port includes a filter element disposed inside the fuel tank and filtering stored fuel stored in the fuel tank by allowing the stored fuel to pass through to an inner space, and a partition wall element disposed in a posture with which to divide the inner space to a first space where filtered fuel filtered at the filter element flows in and a second space where the inlet port into which the filtered fuel is drawn opens, and allowing the filtered fuel in the first space to pass through to the second space.

According to a second aspect of the present disclosure, the fuel supply device supplying fuel from inside a fuel tank to outside the fuel tank in a vehicle includes a fuel pump drawing fuel into an inlet port inside the fuel tank and discharging the fuel outside the fuel tank, and the suction filter set forth in the first aspect.

In the first aspect and the second aspect, a liquid film is formed on the filter element disposed inside the fuel tank when the stored fuel in the fuel tank is passed through to the inner space. Hence, even when the stored fuel migrates to only one side in the sub-tank inside the fuel tank during turning motion or the like of the vehicle and a liquid surface tilts to an extent that the stored fuel loses contact with the filter element, leakage of the stored tank from the inner space can be restricted.

The partition wall element of the first aspect and the second aspect divides the inner space of the filter element to the first space where the filtered fuel from the filter element flows in and the second space where the inlet port of the fuel pump opens. A liquid film is formed on the partition wall element when the filtered fuel in the first space is passed to the second space. Hence, the filtered fuel can be trapped in the first space between the partition wall element and the filter element on which the liquid film is formed as described above.

Hence, according to the first embodiment, even when a liquid surface of the stored fuel tilts in the sub-tank inside the fuel tank, a trapped amount of the filtered fuel in the first space is secured by restricting leakage through the filter element and the filtered fuel remains in contact with the outer surface of the partition wall element on a side of the first space. Accordingly, because a liquid film formation state of the partition wall element can be continuously maintained, a state in which fuel becomes a predominant subject to be drawn into the second space where the inlet port opens can be continuously maintained as well. That is to say, discharge performance of the fuel pump can be stabilized by continuously restricting drawing of air into the inlet port.

### BRIEF DESCRIPTION OF DRAWINGS

The above and other objects, features and advantages of the present disclosure will become more apparent from the following detailed description made with reference to the accompanying drawings. In the drawings:

FIG. 1 is a cross section of a fuel supply device of a first embodiment;

FIG. 2 is an enlarged cross section of a suction filter of the first embodiment;

FIG. 3 is a cross section used to describe a functional effect of the suction filter of the first embodiment;

FIG. 4 is an enlarged cross section of a suction filter of a second embodiment;

FIG. 5 is a cross section taken along the line of V-V of FIG. 4;

FIG. 6 is a cross section used to describe a functional effect of the suction filter of the second embodiment;

FIG. 7 is an enlarged cross section of a suction filter of a third embodiment;

FIG. 8 is a cross section used to describe a functional effect of the suction filter of the third embodiment;

FIG. 9 is an enlarged cross section of a suction filter of a fourth embodiment;

FIG. 10 is a cross section showing a state of the suction filter of the fourth embodiment different from a state shown in FIG. 9;

FIG. 11 is a cross section used to describe a functional effect of the suction filter of the fourth embodiment;

FIG. 12 is a cross section showing a modification of a configuration of FIG. 2;

FIG. 13 is another cross section showing the modification of the configuration of FIG. 2;

FIG. 14 is a cross section showing a modification of a configuration of FIG. 7;

FIG. 15 is another cross section showing the modification of the configuration of FIG. 7;

FIG. 16 is a cross section showing another modification of the configuration of FIG. 7;

FIG. 17 is another cross section showing the secondly-mentioned modification of the configuration of FIG. 7;

FIG. 18 is a cross section showing a modification of a configuration of FIG. 4;

FIG. 19 is a cross section showing still another modification of the configuration of FIG. 7;

FIG. 20 is a cross section showing still another modification of the configuration of FIG. 7;

FIG. 21 is a cross section showing still another modification of the configuration of FIG. 7;

FIG. 22 is a cross section showing another modification of the configuration of FIG. 4; and

FIG. 23 is a cross section showing still another modification of the configuration of FIG. 7.

### DESCRIPTION OF EMBODIMENTS

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

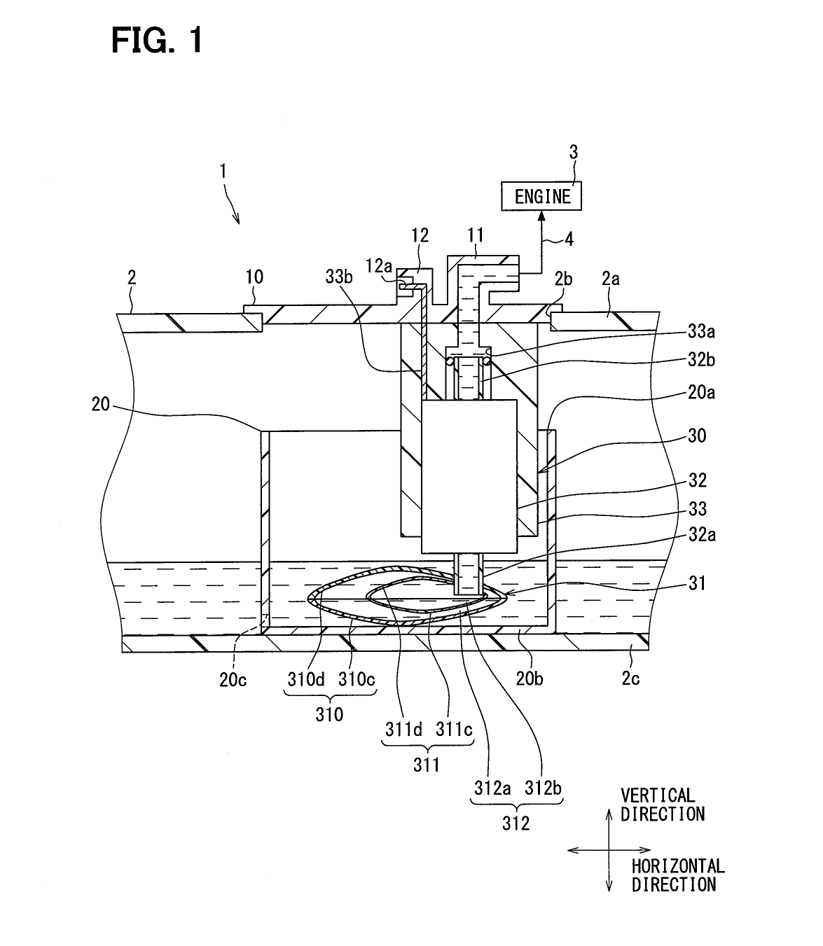

As is shown in FIG. 1, a fuel supply device 1 according to a first embodiment of the present disclosure is installed to a fuel tank 2 of a vehicle. The fuel supply device 1 supplies fuel inside the fuel tank 2 to an internal combustion engine 3 outside the fuel tank 2. The fuel tank 2 equipped with the fuel supply device 1 is made of resin and formed in a hollow shape to store fuel to be supplied to a side of the internal combustion engine 3. The internal combustion engine 3 supplied with fuel from the fuel supply device 1 may be a gasoline engine or a diesel engine. A horizontal direction and a vertical direction in the vehicle on a level surface substantially coincides, respectively, with a horizontal direction and a vertical direction specified in FIG. 1.

An overall configuration of the fuel supply device 1 will be described first.

The fuel supply device 1 includes a flange 10, a sub-tank 20, and a pump unit 30.

The flange 10 is made of hard resin and formed in a circular plate shape. The flange 10 is attached to a top board portion 2a of the fuel tank 2. The flange 10 closes a through-hole 2b penetrating through the top board portion 2a.

The flange 10 integrally has a fuel supply tube 11 and an electrical connector 12. The fuel supply tube 11 communicates with the pump unit 30 inside the fuel tank 2. The fuel supply tube 11 also communicates with a fuel path 4 led to the internal combustion engine 3 outside the fuel tank 2. Owing to such a communication configuration of the fuel supply tube 11, fuel drawn by a fuel pump 32 of the pump unit 30 inside the fuel tank 2 is supplied to the internal combustion engine 3 outside the fuel tank 2. A metal terminal 12a is embedded in the electrical connector 12. The metal terminal 12a is electrically connected to the pump unit 30 inside the fuel tank 2. The metal terminal 12a is also electrically connected to an external control circuit outside the fuel tank 2. Owing to such an electrical connection configuration, the fuel pump 32 of the pump unit 30 can be controlled by the external control circuit.

The sub-tank 20 is made of hard resin and formed in a bottomed-cylindrical shape. The sub-bank 20 is disposed inside the fuel tank 2 with an opening 20a faced upward. A bottom 20b of the sub-tank 20 is disposed on a bottom 2c of the fuel tank 2. An inflow port 20c penetrates through the sub-tank 20 near the bottom 20b. Owing to such a penetration configuration, fuel stored in the fuel tank 2 flows into the sub-tank 20 through the inflow port 20c. In the present embodiment, fuel stored in the fuel tank 2 is referred to as the stored fuel.

The pump unit 30 is disposed inside the fuel tank 2 to extend both inside and outside the sub-tank 20. The pump unit 30 is provided with a suction filter 31, the fuel pump 32, and a passage member 33.

The suction filter 31 as a whole is formed in a flat shape. The suction filter 31 is housed inside the fuel tank 2 and disposed on the bottom 20b of the sub-tank 20. The suction filter 31 filters out foreign matter from the stored fuel by filtering the stored fuel which has flowed into the sub-tank 20 inside the fuel tank 2.

The fuel pump 32 is an electrical pump formed in a circular cylindrical shape as a whole. The fuel pump 32 is housed inside the fuel tank 2 and located above the suction filter 31 while extending from inside the sub-tank 20 to outside the sub-tank 20. An inlet port 32a of the fuel pump 32 communicates with the suction filter 31. The fuel pump 32 operates under control of the external control circuit. The fuel pump 32 in operation draws fuel filtered at the suction filter 31 in the sub-tank 20 inside the fuel tank 2 from the inlet port 32a. The filtered fuel drawn into the inlet port 32a is pressurized in the fuel pump 32 and discharged from a discharge port 32b of the fuel pump 32 to head toward the internal combustion engine 3 outside the fuel tank 2. In the present embodiment, fuel filtered at the suction filter 31 in the sub-tank 20 inside the fuel tank 2 is referred to as the filtered fuel.

The passage member 33 is made of hard resin and formed in a hollow shape. The passage member 33 is housed inside the fuel tank 2 and fixed to the flange 10 while extending from inside the sub-tank 20 to outside the sub-tank 20 on a periphery of the fuel pump 32. The passage member 33 defines a fuel passage 33a which communicates with both of the discharge port 32b and the fuel supply tube 11. The fuel passage 33a supplies fuel discharged from the discharge port 32b by the fuel pump 32 to the side of the internal combustion engine 3 through the fuel supply tube 11. A metal lead wire 33b is embedded in the passage member 33 to electrically connect the fuel pump 32 to the metal terminal 12a.

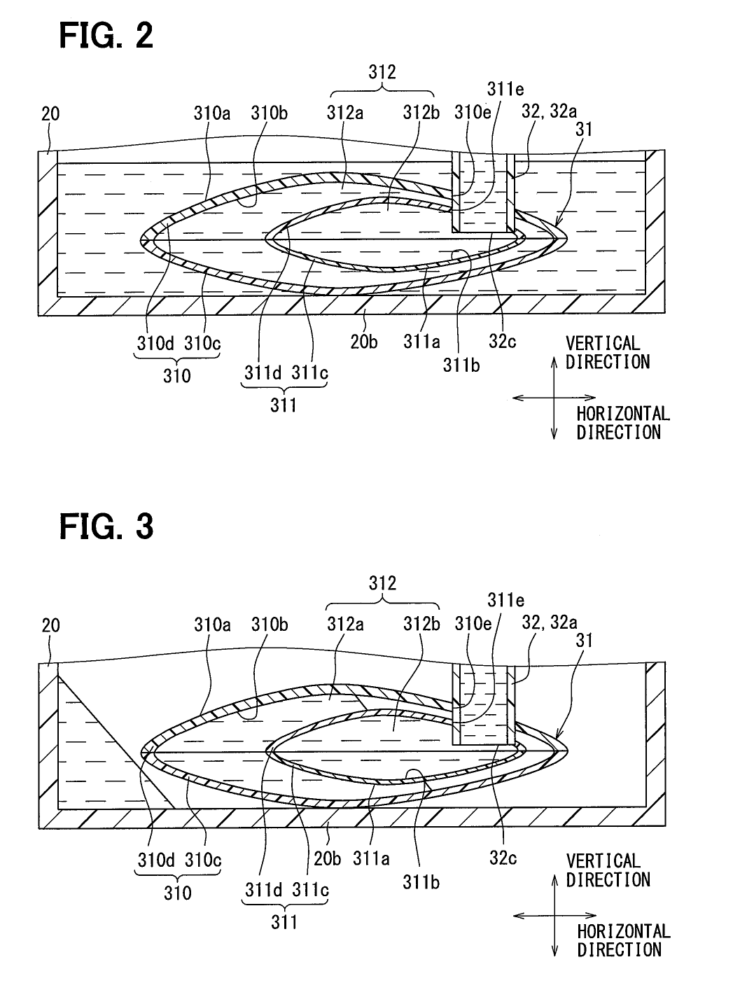

A detailed configuration of the suction filter 31 will now be described. As are shown in FIGS. 1 and 2, the suction filter 31 includes a filter element 310 and a partition wall element 311 in combination.

As is shown in FIG. 2, the filter element 310 is provided in the sub-tank 20 inside the fuel tank 2 and formed in a hollow sac shape with an outer surface 310a being exposed and an inner surface 310b enclosing an inner space 312. The filter element 310 of the present embodiment is formed by liquid-tightly bonding a pair of filter sheets 310c and 310d along respective outer peripheral edges. The respective filter sheets 310c and 310d are made entirely of a material which exerts a filtering function, for example, porous resin, woven cloth, non-woven cloth, a resin mesh, or a metal mesh and provided in a form of soft or hard curved filters. Roughness fine enough to filter out, for example, fine foreign matter having a major diameter, for example, at least as small as 10 μm from the stored fuel which has flowed into the sub-tank 20 from inside the fuel tank 2 is set to the respective filter sheets 310c and 310d.

Regarding the filter element 310, the filter sheet 310d on an upper side (hereinafter, referred to as an upper filter sheet 310d) is bonded on top of the filter sheet 310c on a lower side (hereinafter, referred to as a lower filter sheet 310c) and provided with a through-hole 310e. The inlet port 32a of the fuel pump 32 penetrates through the through-hole 310e toward the inner space 312 from outside the filter element 310. The through-hole 310e is liquid-tightly bonded to the inlet port 32a at a level upper than an opening 32c of the inlet port 32a that faces downward. Owing to such penetration and bonding configurations, as are shown in FIGS. 1 and 2, the filter element 310 is disposed in such a manner that the upper filter sheet 310d is supported on the fuel tank 2 via the pump unit 30 and the flange 10 whereas a part of the lower filter sheet 310c is brought into contact with the bottom 20b of the sub-tank 20.

The filter element 310 configured as above exerts the filtering function by filtering out foreign matter at a passing point of the stored fuel when the stored fuel which is flowed into the sub-tank 20 from inside the fuel tank 2 is passed through to the inner space 312. The passing point of the stored fuel means voids in micro-pores in a case where a formation material of the filter element 310 is porous resin, voids in fibers in a case where the formation material is woven cloth or non-woven cloth, and voids in a mesh in a case where the formation material is a resin mesh or a metal mesh. Hence, the stored fuel is trapped in the voids due to surface tension at the passing point and a liquid film covering the outer surface 310a of the filter element 310 is formed at a same time when the filtering function is exerted. In short, the filter element 310 exerts the filtering function on the stored fuel while forming a liquid film on the outer surface 310a. In order to filter out foreign matter having the major diameter specified above at the passing point of the stored fuel, roughness of the filter element 310 is set by setting minimum intervals of voids as the passing point to, for example, about 10 μm.

In contrast to the filter element 310 configured as above, the partition wall element 311 is disposed in a posture with which to completely divide the inner space 312 of the filter element 310 to a first space 312a and a second space 312b in the sub-tank 20 inside the fuel tank 2. As is shown in FIG. 2, the partition wall element 311 of the present embodiment is provided in the inner space 312 and formed in a hollow sac shape with an outer surface 311a being exposed to the first space 312a and an inner surface 311b completely enclosing the second space 312b. Also, the partition wall element 311 of the present embodiment is formed by liquid-tightly bonding a pair of partition wall sheets 311c and 311d along respective outer peripheral edges so as to cover the first space 312a in cooperation with the filter element 310. The respective partition wall sheets 311c and 311d are made entirely of a material which exerts the filtering function, for example, porous resin, woven cloth, non-woven cloth, a resin mesh, or a metal mesh and provided in a form of soft or hard curved sheets. For the partition wall element 311 to allow foreign matter which has passed through the filter element 310 to also pass through, same or a higher degree of roughness than the roughness of the respective filter sheets 310c and 310d is set to the respective partition wall sheets 311c and 311d.

Regarding the partition wall element 311, the partition wall sheet 311d on the upper side (hereinafter, referred to an upper partition wall sheet 311d) is bonded on top of the partition wall sheet 311c on the lower side (hereinafter, referred to as a lower partition wall sheet 311c) and provided with a through-hole 311e. The inlet port 32a of the fuel pump 32 penetrates through the through-hole 311e toward the second space 312b on an inner side of the partition wall element 311 from the first space 312a on an outer side of the partition wall element 311. The through-hole 311e is liquid-tightly bonded to the inlet port 32a at a level upper than the opening 32c of the inlet port 32a opening to the second space 312b. Owing to such penetration and bonding configurations, as are shown in FIGS. 1 and 2, the partition wall element 311 is disposed in such a manner that the upper partition wall sheet 311d is supported on the fuel tank 2 via the pump unit 30 and the flange 10 whereas the lower partition wall sheet 311c is entirely spaced apart upward from the lower filter sheet 310c of the filter element 310. In addition, the opening 32c of the inlet port 32a is spaced apart upward from the lower partition wall sheet 311c only on the upper side in the second space 312b. Hence, the opening 32c hardly attracts the lower partition wall sheet 311c even under action of an inlet pressure.

The partition wall element 311 configured as above allows the filtered fuel which has been filtered at the respective filter sheets 310c and 310d forming the filter element 310 and flowed into the first space 312a on the outer side to pass through to the second space 312b where the inlet port 32a opens. A passing point of the filtered fuel means voids in micro-pores in a case where a formation material of the partition wall element 311 is porous resin, voids in fibers in a case where the formation material is woven cloth or non-woven cloth, and voids in a mesh in a case where the formation material is a resin mesh or a metal mesh. Hence, the filtered fuel is trapped in voids due to surface tension at the passing point and a liquid film covering the outer surface 311a of the partition wall element 311 is formed. In order to allow the foreign matter specified above to pass through the passing point of the filtered fuel, roughness of the respective partition wall sheets 311c and 311d is set by setting minimum intervals of voids as the passing point to, for example, about 10 to 100 μm.

The following will describe a functional effect of the first embodiment described above.

In the first embodiment, a liquid film is formed on the filter element 310 disposed inside the fuel tank 2 when the stored fuel in the fuel tank 2 is passed through to the inner space 312. Hence, even when the stored fuel migrates to only one side in the sub-tank 20 inside the fuel tank 2 during turning motion or the like of the vehicle and a liquid surface tilts to an extent that the stored fuel loses contact with the filter element 310 as is shown in FIG. 3, leakage of the stored tank from the inner space 312 can be restricted.

The partition wall element 311 of the first embodiment divides the inner space 312 of the filter element 310 to the first space 312a where the filtered fuel from the filter element 310 flows in and the second space 312b where the inlet port 32a of the fuel pump 32 opens. A liquid film is formed on the partition wall element 311 when the filtered fuel in the first space 312a is passed to the second space 312b. Hence, as is shown in FIG. 3, the filtered fuel can be trapped in the first space 312a between the partition wall element 311 and the filter element 310 on which the liquid film is formed as described above.

Hence, according to the first embodiment, even when a liquid surface of the stored fuel tilts in the sub-tank 20 inside the fuel tank 2, as is shown in FIG. 3, a trapped amount of the filtered fuel in the first space 312a is secured by restricting leakage through the filter element 310 and the filtered fuel remains in contact with the outer surface 311a of the partition wall element 311 on a side of the first space 312a. Accordingly, because a liquid film formation state of the partition wall element 311 can be continuously maintained, a state in which fuel becomes a predominant subject to be drawn into the second space 312b where the inlet port 32a opens can be continuously maintained as well. That is to say, discharge performance of the fuel pump 32 can be stabilized by continuously restricting drawing of air into the inlet port 32a. Moreover, because fuel discharged from the fuel pump 32 is supplied to the side of the internal combustion engine 3 outside the fuel tank 2 in the first embodiment, drivability and acceleration of the vehicle can be ensured and running out of gas and an engine failure can be restricted by stabilizing discharge performance of the fuel pump 32.

According to the first embodiment, the partition wall element 311 is formed in a hollow sac shape and divides the inner space 312 of the filter element 310 while being exposed to the first space 312a on the outer side and enclosing the second space 312b on the inner side. Hence, a surface area of the outer surface 311a of the partition wall element 311 exposed to the first space 312a can be increased to a fullest extent possible. Consequently, even in a case where the filtered fuel in the first space 312a is drawn into the inlet port 32a and decreases when a liquid surface tilts in the sub-tank 20 inside the fuel tank 2, the partition wall element 311 hardly loses contact with the filtered fuel in the first space 312a and is therefore capable of maintaining a liquid film formation state. Hence, discharge performance of the fuel pump 32 can be stabilized further by continuously restricting drawing of air into the inlet port 32a in a reliable manner.

According to the first embodiment, same or a higher degree of roughness than the roughness of the filter element 310 which allows the stored fuel to pass through is set to the partition wall element 311 to allow the filtered fuel to pass through. Hence, in spite of a fact that the partition wall element 311 is configured to divide the inner space 312 of the filter element 310 and therefore has a smaller surface area than the filter element 310, clogging of the partition wall element 311 by foreign matter allowed to pass through the filter element 310 can be restricted. Consequently, an inconvenience that clogging of the partition wall element 311 impairs stability of discharge performance of the fuel pump 32 can be avoided.

### Second Embodiment

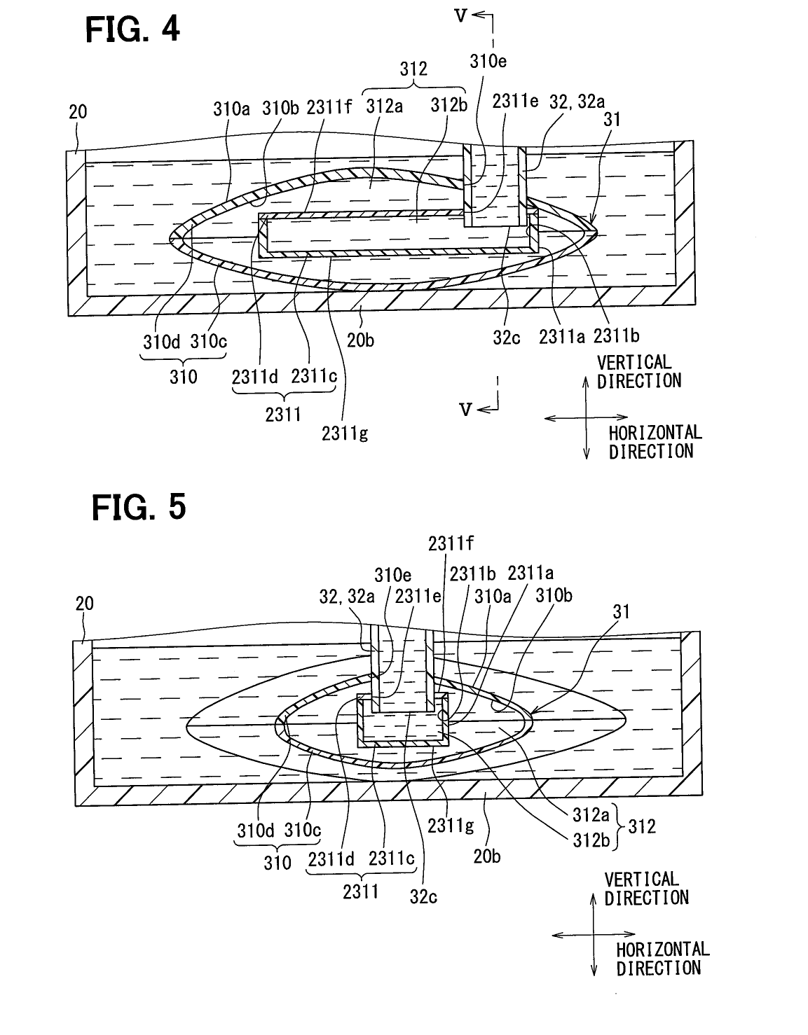

As are shown in FIGS. 4 and 5, a second embodiment of the present disclosure is a modification of the first embodiment above. A partition wall element 2311 of the second embodiment is formed in a hollow cylindrical shape in the inner space 312 of the filter element 310 with an outer surface 2311a being exposed to the first space 312a and an inner surface 2311b completely enclosing the second space 312b. In particular, the partition wall element 2311 is formed by liquid-tightly bonding a pair of partition wall members 2311c and 2311d in such a manner that a rectangular cylindrical shape is formed by connecting an upper wall 2311f and a lower wall 2311g substantially parallel to bottoms 2c and 20b of the tanks 2 and 20, respectively, with four walls. Owing to such a configuration, the partition wall element 2311 completely divides the inner space 312 of the filter element 310 to the first space 312a and the second space 312b in the sub-tank 20 inside the fuel tank 2. When the respective partition wall members 2311c and 2311d forming the partition wall element 2311 are entirely made of the formation material of the respective partition wall sheets 311c and 311d specified in the first embodiment above, roughness of the partition wall members 2311c and 2311d can be same as the roughness specified in the first embodiment above.

Regarding the partition wall element 2311, the partition wall member 2311d on an upper side (hereinafter, referred to as the upper partition wall member 2311d) is bonded on top of the partition wall member 2311c on a lower side (hereinafter, referred to as the lower partition wall member 2311c) and provided with a through-hole 2311e. The inlet port 32a of the fuel pump 32 penetrates through the through-hole 2311e from the first space 312a outside the partition wall element 2311 toward the second space 312b inside the partition wall element 2311. The through-hole 2311e is liquid-tightly bonded to the inlet port 32a at a level upper than the opening 32c of the inlet port 32a. Owing to such penetration and bonding configurations, the partition wall element 2311 is disposed in such a manner that the upper partition wall member 2311d is supported on the fuel tank 2 via the pump unit 30 and the flange 10 whereas the lower partition wall member 2311c is entirely spaced apart upward from the lower filter sheet 310c of the filter element 310. In addition, the opening 32c of the inlet port 32a is spaced apart upward from the lower partition wall member 2311c only on the upper side in the second space 312b. Hence, the opening 32c hardly attracts the lower wall 2311g of the lower partition wall member 2311c even under action of an inlet pressure.

The partition wall element 2311 configured as above allows filtered fuel which has been filtered at respective filter sheets 310c and 310d forming the filter element 310 and flowed into the first space 312a on an outer side to pass through to the second space 312b on an inner side where the inlet port 32a opens. A passing point of the filtered fuel is voids in respective formation materials as described in the first embodiment above. Hence, a liquid film covering the outer surface 2311a of the partition wall element 2311 is formed at the passing point when the filtered fuel is trapped in the voids due to surface tension. In order to allow foreign matter same as the foreign matter of the first embodiment above to pass through the passing point of the filtered fuel, roughness of the respective partition wall members 2311c and 2311d is set by setting minimum intervals of voids as the passing point to, for example, about 10 to 100 μm.

The following will describe a functional effect of the second embodiment described above.

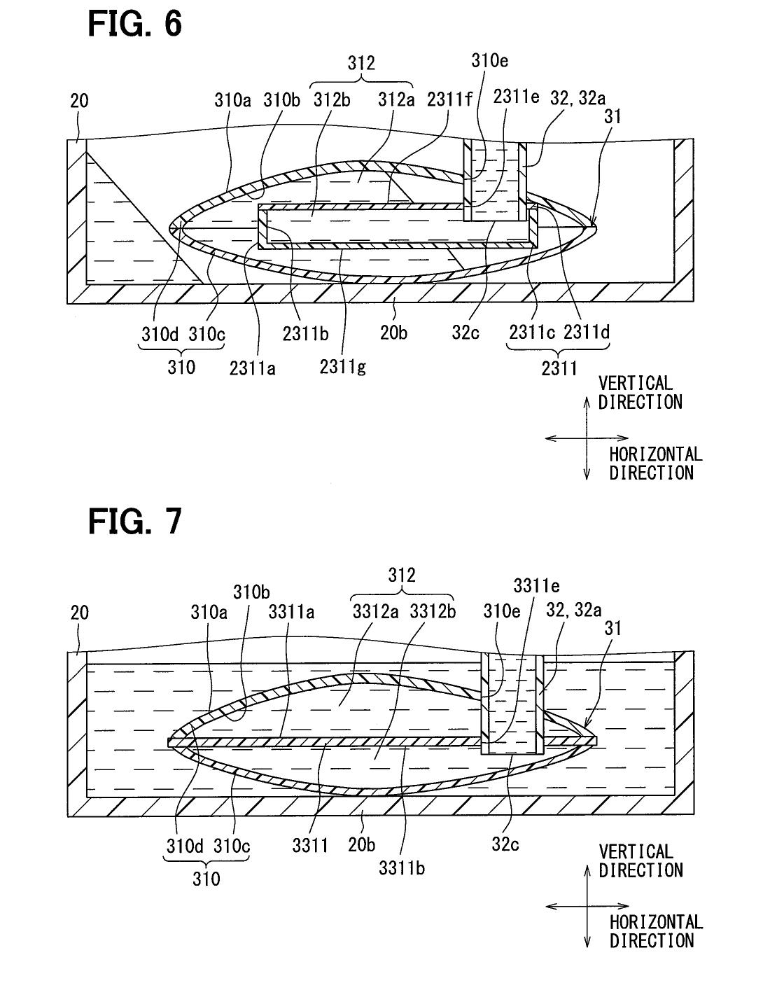

The partition wall element 2311 of the second embodiment divides the inner space 312 of the filter element 310 to the first space 312a where the filtered fuel flows in and the second space 312b where the inlet port 32a opens. It should be noted that a liquid film is formed on the partition wall element 2311 when the filtered fuel in the first space 312a is passed through to the second space 312b. Accordingly, the filtered fuel can be trapped as is shown in FIG. 6 in the first space 312a between the partition wall element 2311 and the filter element 310 on which a liquid film is formed in the same manner as in the first embodiment above. Hence, in accordance with a principle underlying the first embodiment above, because a liquid film formation state of the partition wall element 2311 can be continuously maintained, a state in which fuel becomes a predominant subject to be drawn into the second space 312b where the inlet port 32a opens can be continuously maintained as well. Hence, discharge performance of the fuel pump 32 can be stabilized by continuously restricting drawing of air into the inlet port 32a. Consequently, drivability and acceleration of a vehicle can be ensured and running out of gas and an engine failure can be restricted.

According to the second embodiment, the partition wall element 2311 is formed in a hollow cylindrical shape and divides the inner space 312 of the filter element 310 while being exposed to the first space 312a on the outer side and enclosing the second space 312b on the inner side. Owing to such a configuration, a surface area of the outer surface 2311a of the partition wall element 2311 exposed to the first space 312a can be increased to a fullest extent possible. Hence, in accordance with the principle underlying the first embodiment above, the liquid film formation state of the partition wall element 2311 can be maintained. Consequently, discharge performance of the fuel pump 32 can be stabilized further by restricting drawing of air into the inlet port 32a in a reliable manner.

In the second embodiment, too, same or a higher degree of roughness than the roughness of the filter element 310 which allows the stored fuel to pass through is set to the partition wall element 2311 to allow the filtered fuel to pass through. Hence, clogging of the partition wall element 2311 by foreign matter can be restricted in accordance with the principle underlying the first embodiment above. Consequently, an inconvenience that clogging impairs stability of discharge performance of the fuel pump 32 can be avoided.

### Third Embodiment

As is shown in FIG. 7, a third embodiment of the present disclosure is another modification of the first embodiment above. A partition wall element 3311 of the third embodiment is provided in a form of a partition film which completely divides the inner space 312 of the filter element 310 to an upper first space 3312a and a lower second space 3312b in the sub-tank 20 inside the fuel tank 2. In particular, the partition wall element 3311 is bonded between filter sheets 310c and 310d all along respective outer peripheral edges and therefore stretched across the inner space 312 in a form of a flat film. Owing to such a bonding configuration, the first space 3312a is enclosed by the partition wall element 3311 and the upper filter sheet 310d, and an upper surface 3311a of the partition wall element 3311 is thus exposed to the first space 3312a. Also, the second space 3312b is enclosed by the partition wall element 3311 and the lower filter sheet 310c and a lower surface 3311b of the partition wall element 3311 is thus exposed to the second space 3312b. When the partition wall element 3311 is entirely made of the formation material of the respective partition wall sheets 311c and 311d specified in the first embodiment above, roughness of the partition wall element 3311 can be same as the roughness specified in the first embodiment above. Further, the partition wall element 3311 completely divides the inner space 312 of the filter element 310 to make a volume of the second space 3312b smaller than a volume of the first space 3312a.

The partition wall element 3311 is provided with a through-hole 3311e. The inlet port 32a of the fuel pump 32 penetrates through the through-hole 3311e from the first space 3312a above the partition wall element 3311 toward the second space 3312b below the partition wall element 3311. The through-hole 3311e is liquid-tightly bonded to the inlet port 32a at a level upper than the opening 32c of the inlet port 32a. Owing to such penetration and bonding configurations, the partition wall element 3311 is supported on the fuel tank 2 via the pump unit 30 and the flange 10 and most of the partition wall element 3311 except for an outer peripheral edge is spaced apart upward from the lower filter sheet 310c of the filter element 310. In addition, the opening 32c of the inlet port 32a is spaced apart upward from the lower filter sheet 310c only on an upper side in the second space 3312b. Hence, the opening 32c hardly attracts the lower filter sheet 310c even under action of an inlet pressure.

The partition wall element 3311 configured as above allows filtered fuel which has been filtered at the upper filter sheet 310d of the filter element 310 and flowed into the upper first space 3312a to pass through to the lower second space 3312b where the inlet port 32a opens. A passing point of the filtered fuel is voids in respective formation materials as described in the first embodiment above. Because the filtered fuel is trapped in voids due to surface tension at the passing point, a liquid film covering the upper surface 3311a of the partition wall element 3311 is formed. In order to allow foreign matter same as the foreign matter specified in the first embodiment above to pass through the passing point of the filtered fuel, roughness of the partition wall element 3311 is set by setting minimum intervals of the voids as the passing point to, for example, about 10 to 100 μm. In the third embodiment, the filtered fuel filtered at the lower filter sheet 310c of the filter element 310 is allowed to directly flow into the second space 3312b without having to pass through the partition wall element 3311.

The following will describe a functional effect of the third embodiment described above.

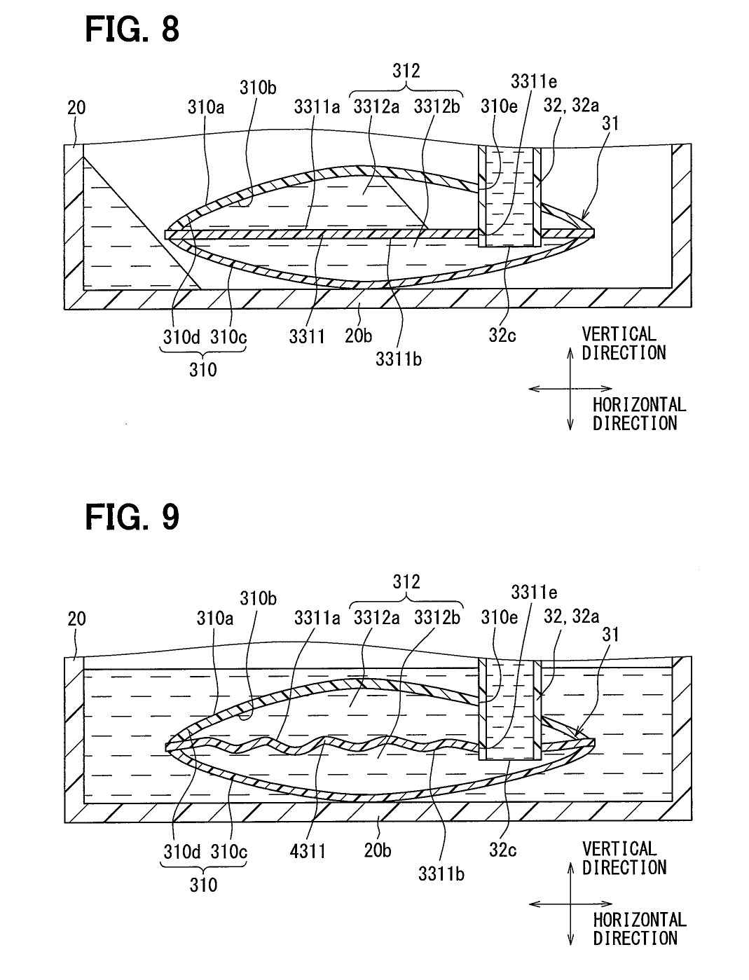

The partition wall element 3311 of the third embodiment divides the inner space 312 of the filter element 310 to the first space 3312a where the filtered fuel flows in and the second space 3312b where the inlet port 32a opens. A liquid film is formed on the partition wall element 3311 when the filtered fuel in the first space 3312a is passed through to the second space 3312b. Hence, as is shown in FIG. 8, the filtered fuel can be trapped in the first space 3312a between the partition wall element 3311 and the filter element 310 on which a liquid film is formed in the same manner as in the first embodiment above. That is to say, in accordance with the principle underlying the first embodiment above, because a liquid film formation state of the partition wall element 3311 can be continuously maintained, a state in which fuel becomes a predominant subject to be drawn into the second space 3312b where the inlet port 32a opens can be continuously maintained as well. Hence, discharge performance of the fuel pump 32 can be stabilized by continuously restricting drawing of air into the inlet port 32a. Consequently, drivability and acceleration of a vehicle can be ensured and running out of gas and an engine failure can be restricted.

The partition wall element 3311 of the third embodiment is provided in the form of a partition film and divides the inner space 312 of the filter element 310 to the upper first space 3312a and the lower second space 3312b. Hence, a liquid film formation state of the partition wall element 3311 is maintained and the filtered fuel can be stored in the second space 3312b in the sub-tank 20 inside the fuel tank 2 until a liquid surface falls to the second space 3312b due to a reduction of the stored fuel. Consequently, discharge performance of the fuel pump 32 can be stabilized further by continuously restricting drawing of air into the inlet port 32a.

In the third embodiment, too, same or a higher degree of roughness than the roughness of the filter element 310 which allows the stored fuel to pass through is set to the partition wall element 3311 to allow the filtered fuel to pass through. Hence, clogging of the partition wall element 3311 by foreign matter can be restricted in accordance with the principle underlying the first embodiment above. Consequently, an inconvenience that clogging impairs stability of discharge performance of the fuel pump 32 can be avoided.

According to the third embodiment, a volume of the second space 3312b is smaller than a volume of the first space 3312a. Hence, even when air is drawn into the second space 3312b while the filtered fuel in the first space 3312a is drawn into the inlet port 32a and runs out, air is not drawn into the inlet port 32a and an amount of the filtered fuel remaining in the second space 3312b is reduced instead. Such a phenomenon is attributed to a fact that when air accounts for a predetermined percentage or more of a volume in the second space 3312b, substantially air alone is drawn into the inlet port 32a and the filtered fuel remains in the second space 3312b and an amount of remaining filtered fuel is reduced more as a volume of the second space 3312b becomes smaller. Hence, according to the third embodiment, discharge performance of the fuel pump 32 can be stabilized further by effectively using the filtered fuel trapped in the second space 3312b.

### Fourth Embodiment

As is shown in FIG. 9, a fourth embodiment of the present disclosure is a modification of the third embodiment above. A partition wall element 4311 of the fourth embodiment is made entirely of a material which exerts a filtering function, for example, porous resin, woven cloth, non-woven cloth, a resin mesh, or a metal mesh, and provided in a form of a flexible soft partition film. The partition wall element 4311 is bonded between filter sheets 310c and 310d all along respective outer peripheral edges and disposed in the inner space 312 in a wavy loose state to become capable of expanding and contracting a second space 3312b. Other than flexibility and the loose state as above, the partition wall element 4311 is of a configuration same as the configuration of the counterpart of the third embodiment.

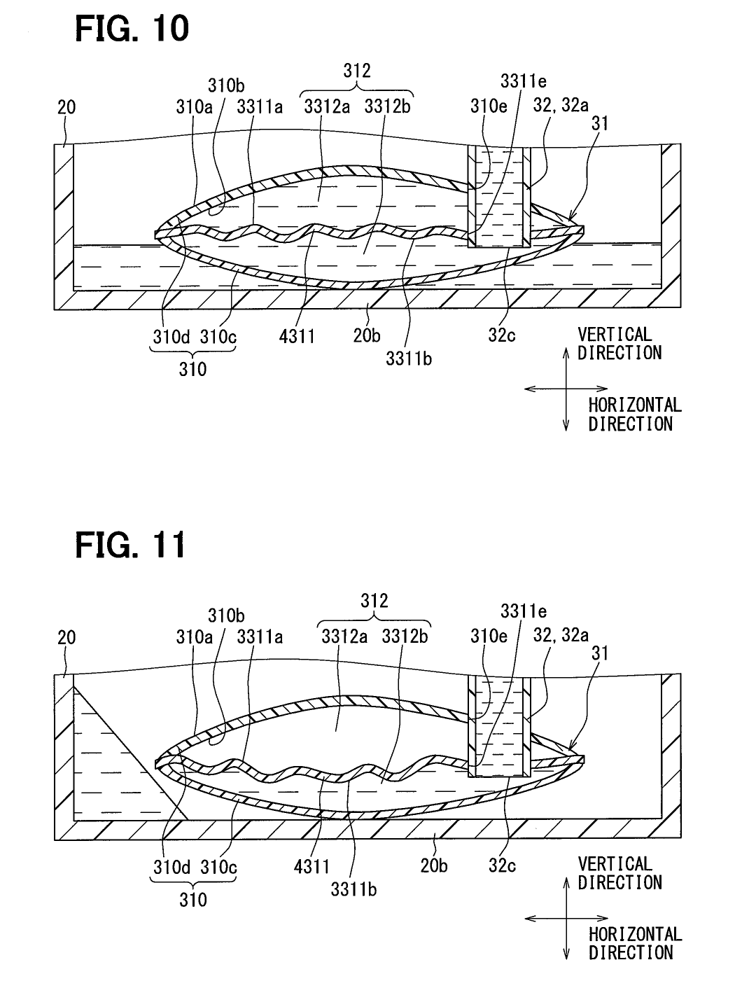

The following will describe a principle in accordance with which the second space 3312b is expanded and contracted by the partition wall element 4311 configured as above. As are shown in FIGS. 9 and 10, the inner space 312 is filled with filtered fuel while stored fuel is in contact with at least the lower filter sheet 310c of the filter element 310 in the sub-tank 20 inside the fuel tank 2. The partition wall element 4311 maintains the second space 3312b in a state where a volume is expanded by moving away from the lower filter sheet 310c almost entirely except for an outer peripheral edge. A volume of the second space 3312b may be larger than, smaller than or equal to a volume of a first space 3312a.

Meanwhile, as is shown in FIG. 11, when a liquid surface of the stored fuel tilts in the sub-tank 20 inside the fuel tank 2, filtered fuel in the first space 3312a is drawn into the inlet port 32a and may possibly run out. In such circumstances, the partition wall element 4311 gradually moves closer to the lower filter sheet 310c while the filtered fuel is drawn into the inlet port 32a and a volume of the second space 3312b is thus reduced gradually. While a volume of the second space 3312b is reduced gradually, the volume of the second space 3312b becomes smaller than a volume of the first space 3312a.

The following will describe a functional effect of the fourth embodiment as above.

The flexible partition wall element 4311 of the fourth embodiment disposed in a loose state is capable of expanding and contracting the second space 3312b. Hence, even when the filtered fuel in the first space 3312a is drawn into the inlet port 32a and substantially runs out, the second space 3312b is contracted by a volume comparable to the filtered fuel drawn from the second space 3312b. Consequently, drawing of air in the first space 3312a into the inlet port 32a through the partition wall element 4311 or drawing air from outside the filter element 310 to inside the filter element 310 and further into the inlet port 32a can be restricted. Hence, drawing of air into the inlet port 32a can be restricted by effectively using also the filtered fuel trapped in the second space 3312b. Consequently, discharge performance of the fuel pump 32 can be stabilized further. In addition, a functional effect same as the functional effect of the third embodiment above can be achieved by the fourth embodiment, too.

### Other Embodiments

The present disclosure is not limited to the embodiments mentioned above, and can be changed and modified to various embodiments which are also within the spirit and scope of the present disclosure.

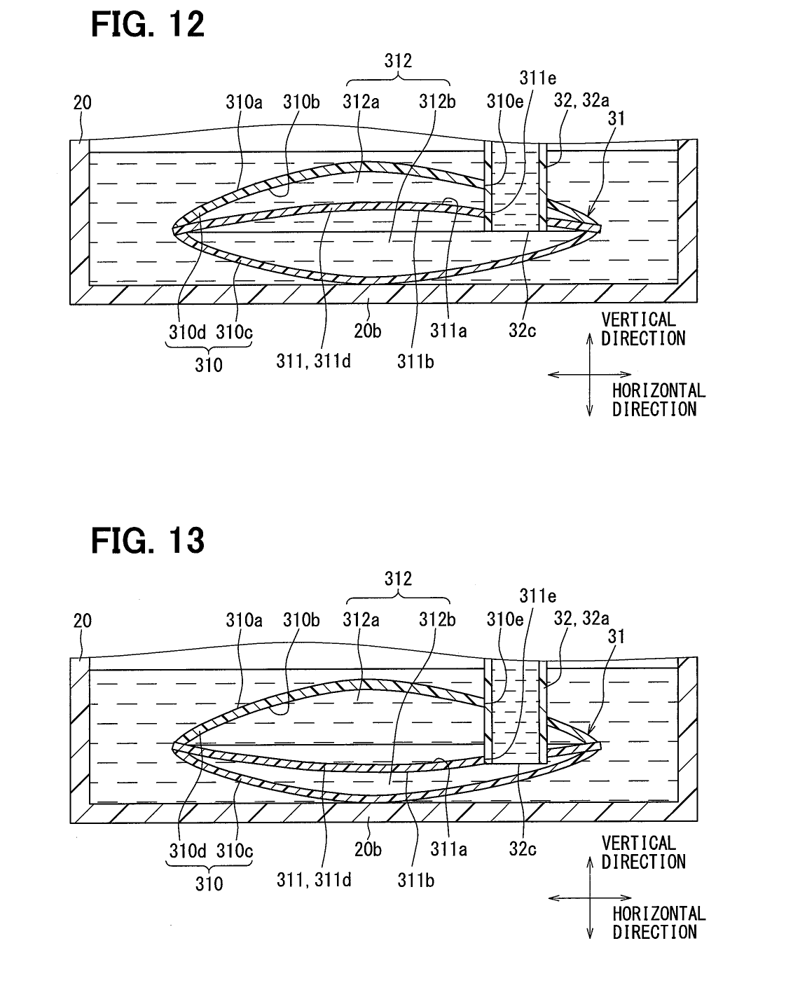

According to a first modification based on the first embodiment above, as are shown in FIGS. 12 and 13, the second space 312b may be enclosed by an upper partition wall sheet 311d in a form of a partition film curved upward or downward provided as the partition wall element 311 and the lower filter sheet 310c of the filter element 310. The partition wall element 311 in the form of a partition film divides the inner space 312 of the filter element 310 to an upper first space 312a and the lower second space 312b. In particular, as is shown in FIG. 13, the inner space 312 of the filter element 310 may be divided by the partition wall element 311 which makes a volume of the second space 312b smaller than a volume of the first space 312a.

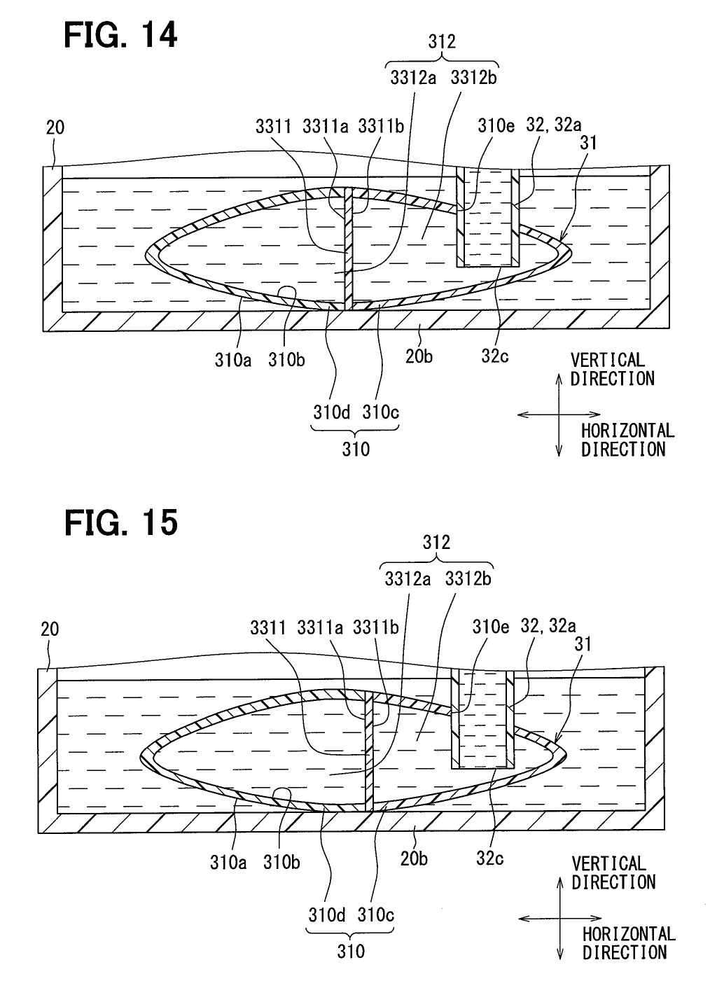

According to a second modification based on the third embodiment above, as are shown in FIGS. 14 and 15, the inner space 312 of the filter element 310 may be divided to the first space 3312a and the second space 3312b in a horizontal direction by the partition wall element 3311 in a form of a partition film without the through-hole 3311e. The filter element 310 is formed by bonding filter sheets 310c and 310d in the horizontal direction and the partition wall element 3311 is bonded between the filter sheets 310c and 310d along respective outer peripheral edges. In particular, as is shown in FIG. 15, the inner space 312 of the filter element 310 may be divided by the partition wall element 3311 which makes a volume of the second space 3312b smaller than a volume of the first space 3312a.

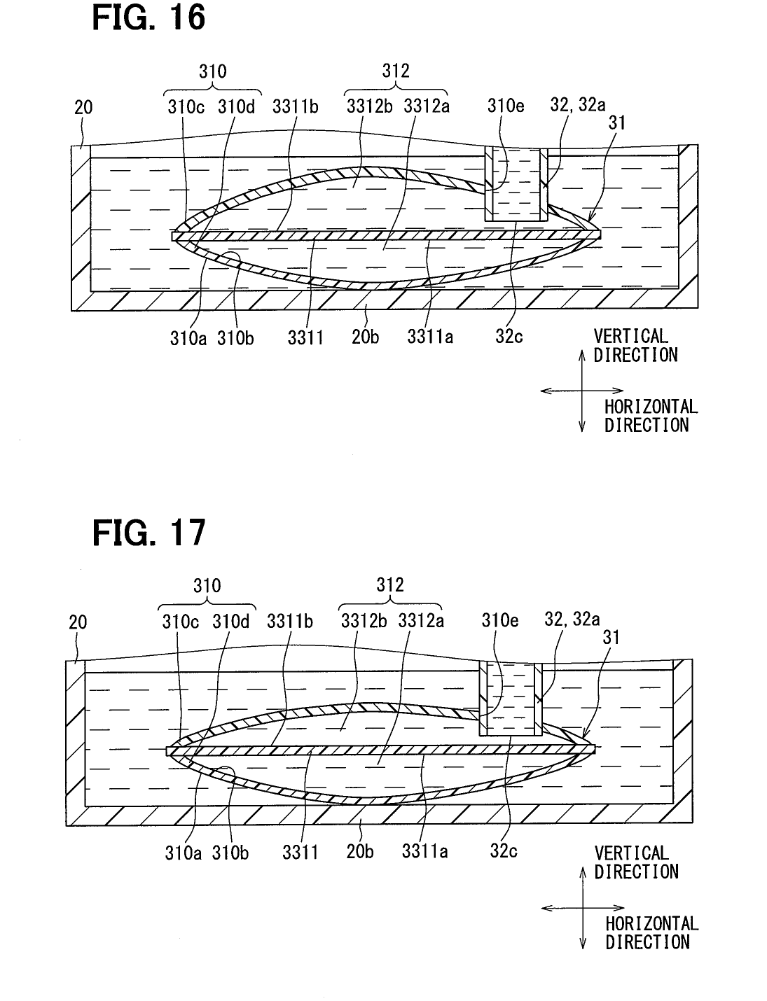

According to a third modification based on the third embodiment above, as are shown in FIGS. 16 and 17, the inner space 312 of the filter element 310 may be divided to a lower first space 3312a and an upper second space 3312b by the partition wall element 3311 in a form of a partition film without the through-hole 3311e. In particular, as is shown in FIG. 17, the inner space 312 of the filter element 310 may be divided by the partition wall element 3311 which makes a volume of the second space 3312b smaller than a volume of the first space 3312a.

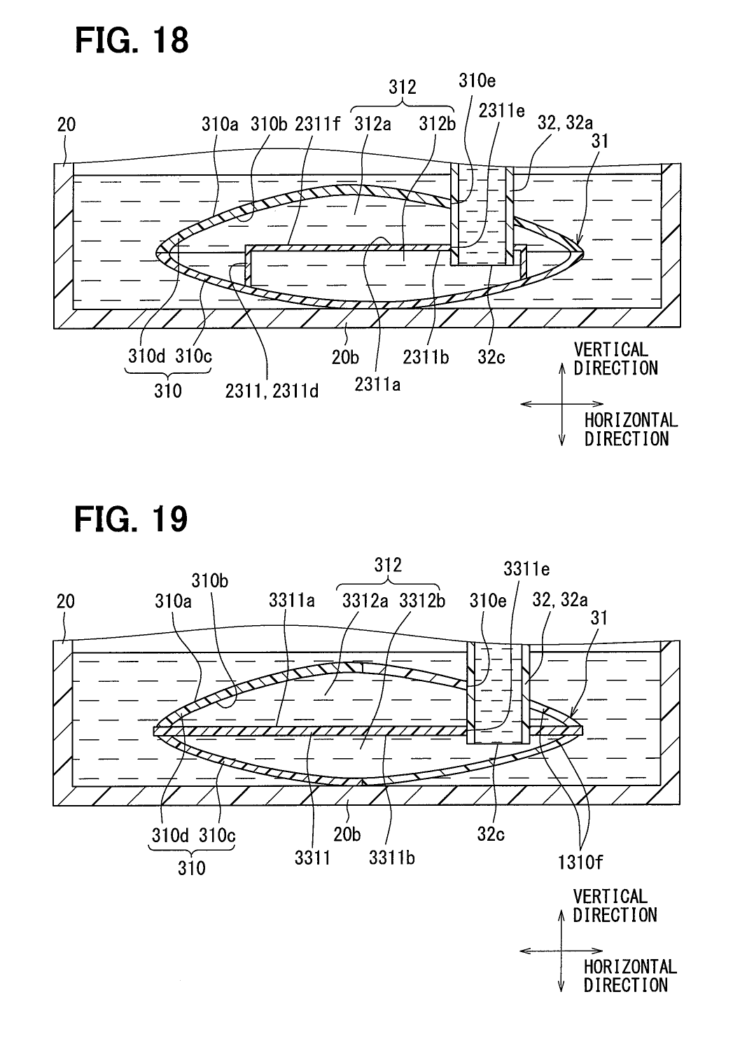

According to a fourth modification based on the second embodiment above, as is shown in FIG. 18, the partition wall element 2311 may omit a lower partition wall member 2311c and include only an upper partition wall member 2311d formed in a hollow inverted bottomed-cylindrical shape (that is, an inverted cup shape) and bonded to the lower filter sheet 310c of the filter element 310. The second space 312b is enclosed by the partition wall element 2311 and the filter element 310 to have a volume smaller than a volume of the first space 312a.

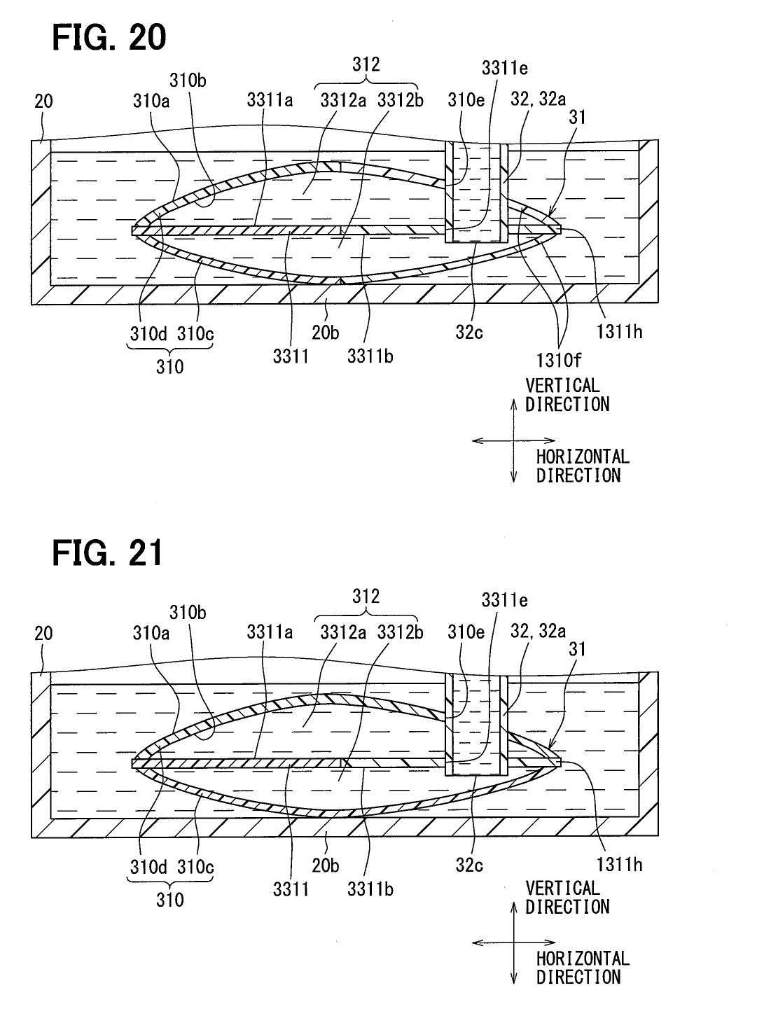

According to a fifth modification based on any one of the first through fourth embodiments above, as are shown in FIGS. 19 and 20, a part 1310f of the filter element 310 made hollow as a whole may be made of a material which does not exert the filtering function, for example, hard resin, instead of a material which exerts the filtering function. FIGS. 19 and 20 show the fifth modification based on the third embodiment above, in which the part 1310f of each of filter sheets 310c and 310d is made of a material which does not exert the filtering function.

According to a sixth modification based on any of the first, third, and fourth embodiments above, as are shown in FIGS. 20 and 21, a part 1311h of any one of partition wall elements 311, 3311, and 4311 formed hollow or in the form of a partition film as a whole may be made of a material which does not exert the filtering function, for example, hard resin, instead of a material which exerts the filtering function. FIGS. 20 and 21 show the sixth modification based on the third embodiment above.

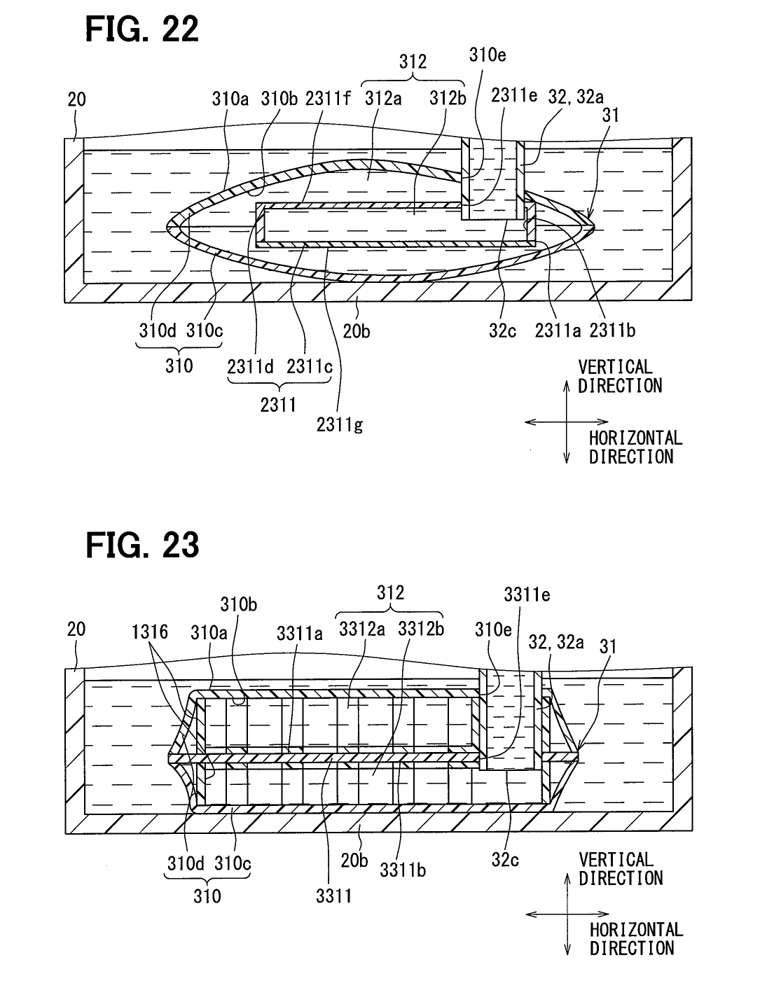

According to a seventh modification based on the second embodiment above, as is shown in FIG. 22, one of partition wall members 2311c and 2311d as a part of a hollow partition wall element 2311 may be made of a material which does not exert the filtering function, for example, hard resin, instead of a material which exerts the filtering function. In the seventh modification shown in FIG. 22 in particular, a lower partition wall member 2311c of a flat plate shape is made of a material which exerts the filtering function whereas an upper partition wall member 2311d formed in a hollow inverted bottomed-cylindrical shape (that is, an inverted cup shape) is made of a material which does not exert the filtering function. When configured in such a manner, filtered fuel trapped in the first space 312a can be used more effectively.

According to an eighth modification based on any one of the first through fourth embodiments above, same or a lower degree of roughness than roughness of the filter element 310 which allows stored fuel to pass through may be set to any one of partition wall elements 311, 2311, 3311, and 4311 to allow the filtered fuel to pass through. According to a ninth modification based on any one of the first through fourth embodiments above, the fuel supply device 1 may adopt a configuration without the sub-tank 20. According to a tenth modification based on any one of the first through fourth embodiments above, the opening 32c of the inlet port 32a of the fuel pump 32 may open in the second space 312b or 3312b in a direction other than a face-down direction, for example, in a horizontal direction.

According to an eleventh modification based on any one of the first through fourth embodiments above, as is shown in FIG. 23, a holding element 1316 as an inner framework of the suction filter 31 may be disposed in the inner space 312 of the filter element 310. FIG. 23 shows the eleventh modification based on the third embodiment above, in which the holding element 1316 made of hard resin is formed substantially in a rib shape. Owing to such a shape, the holding element 1316 holds the partition wall element 3311 from both sides in a vertical direction to expose respective surfaces 3311a and 3311b partially. In addition, the holding element 1316 protrudes to the both sides in the vertical direction from multiple points to maintain a volume relation between the first space 3312a and the second space 3312b and thereby holds respective filter sheets 310c and 310d forming the filter element 310. Further, the holding element 1316 is also attached to the inlet port 32a to maintain a positional relation of the opening 32c in the second space 3312b.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A suction filter which filters fuel inside a fuel tank of a vehicle to let a fuel pump draw filtered fuel into an inlet port, comprising:
a filter element disposed inside the fuel tank and filtering stored fuel stored in the fuel tank by allowing the stored fuel to pass through to an inner space; and
a partition wall element disposed in a posture with which to divide the inner space to a first space where filtered fuel filtered at the filter element flows in and a second space where the inlet port into which the filtered fuel is drawn opens, and allowing the filtered fuel in the first space to pass through to the second space, wherein
the partition wall element is provided in a form of a partition film which divides the inner space to the first space on an upper side and the second space on a lower side.

2. (canceled)

3. (canceled)

4. (canceled)

5. The suction filter according to claim 1, wherein:
the partition wall element is flexible and disposed in a loose state to become capable of expanding and contracting the second space.

6. The suction filter according to claim 1, wherein:
the second space is enclosed by the partition wall element and the filter element.

7. The suction filter according to claim 6, wherein:
a volume of the second space is smaller than a volume of the first space.

8. The suction filter according to claim 1, wherein:
same or a higher degree of roughness than roughness of the filter element which allows the stored fuel to pass through is set to the partition wall element to allow the filtered fuel to pass through.

9. A fuel supply device supplying fuel from inside a fuel tank to outside the fuel tank in a vehicle, comprising:
a fuel pump drawing fuel into an inlet port inside the fuel tank and discharging the fuel outside the fuel tank; and
the suction filter set forth in claim 1.
